(19) United States
(12) Patent Application Publication
(10) Pub. No.: US 2014/0292702 A1
(43) Pub. Date: Oct. 2, 2014

(54) INPUT DEVICE, INPUT DEVICE CONTROL METHOD, CONTROLLED DEVICE, ELECTRONIC WHITEBOARD SYSTEM, AND RECORDING MEDIUM

(71) Applicant: SHARP KABUSHIKI KAISHA, Osaka-shi, Osaka (JP)

(72) Inventors: Mitsuru Samejima, Osaka-shi (JP); Fumihiko Takagi, Osaka-shi (JP)

(73) Assignee: SHARP KABUSHIKI KAISHA, Osaka-shi, Osaka (JP)

(21) Appl. No.: 14/351,780

(22) PCT Filed: Sep. 18, 2012
(86) PCT No.: PCT/JP2012/073843

§ 371 Date: Apr. 14, 2014

(30) Foreign Application Priority Data
Oct. 21, 2011 (JP) 2011-232222

(51) Int. Cl. G06F 3/041; G06F 3/0488

(52) U.S. Cl. CPC G06F 3/0416; G06F 3/04883
USPC 345/173

(57) ABSTRACT

In the present invention, a storage device in which a command (4b) and a pattern (2) are stored in such a manner that the command (4b) and the pattern (2) are associated with each other is referred to, and it is determined whether a track (1) matches the pattern (2). In a case where it is determined that the track (1) does not match the pattern (2), the track (1) is transmitted as a handwritten character (4a), and in a case where it is determined that the track (1) matches the pattern (2), a command (4b) associated with the pattern (2) to which the track (1) matches is transmitted.

### TECHNICAL FIELD

The present invention relates to an input device etc. for transmitting, to a controlled device provided outside, input information inputted into the input device.

### BACKGROUND ART

With wide popularization of electronic devices having display screens with touch panels, there are increasing occasions where users make handwriting inputs to such electronic devices. For example, in cases of information terminals such as so-called smart phones and a part of home video game machines, it is common that users input characters and graphics through handwriting operations using indicators such as a finger and a stylus (hereinafter merely referred to as indicators). Furthermore, recently, electronic whiteboards usable mainly for educational uses have been introduced into educational institutions.

The following description will discuss an electronic whiteboard as an example of an electronic device to which a user can input information through handwriting operations. FIG. 14 is a drawing schematically illustrating an example of use of a general electronic whiteboard. As illustrated in this drawing, the electronic whiteboard is used, for example, in a case where a presenter makes presentation while displaying data. In the presentation, the user can add characters etc. to the data displayed on the electronic whiteboard by making handwriting operations on the electronic whiteboard.

Conventional electronic whiteboards are designed such that user's handwritten tracks on an input region with use of an indicator are directly displayed on a display region, which advantageously enables the user to intuitively feel as if the user were handwriting the tracks on the display region. On the other hand, for example, in a case where the user wants to add small characters etc. on the conventional electronic whiteboard, the user may feel inconvenient as if the user were adding small characters etc. with use of a too thick pen. In contrast, in a case where the user wants to add large characters etc. on the conventional electronic whiteboard, the user takes more troubles when the conventional electronic whiteboard has a larger input region in physical size.

In order to solve the foregoing problem, Patent Literature 1 below describes a handwriting input device capable of downsizing an area of already displayed handwritten information so as to secure a region to which new handwritten information can be input. Patent Literature 2 below describes a handwriting input device which enables a user to handwrite information within a frame larger than a handwriting display range on a display screen, without directly handwriting the information within the handwriting display range. Patent Literature 3 below describes a handwritten character input region setting device which enables a user, when inputting handwritten characters on an input region, to change a size of the input region as desired.

### CITATION LIST

### Patent Literatures

[Patent Literature 1]
Japanese Patent Application Publication No. 2009-116476 (published on May 28, 2009)
[Patent Literature 2]
Japanese Patent Application Publication No. 9-124164 (published on May 6, 1994)
[Patent Literature 3]
Japanese Patent Application Publication No. 5-143770 (published on Jun. 11, 1993)

### SUMMARY OF INVENTION

### Technical Problem

Each of the conventional techniques described in the aforementioned patent literatures tries to solve the foregoing problem by separating an input region from a display region. That is, each of the conventional techniques is designed such that tracks handwritten on an input region with use of an indicator are not directly displayed on a display region but are subjected to a predetermined change and then displayed on the display region.

However, each of the conventional techniques described in the aforementioned patent literatures requires a user to make a troublesome operation. Specifically, the user must carry out a complex operation including several steps (switching of icon modes, setting of a reduction ratio, enlarging operation etc.) before displaying inputted characters etc. subjected to a predetermined process. Furthermore, the operation which the user must carry out is selection of a predetermined menu etc., which is not an intuitive operation taking an advantage of “handwriting operation”.

The present invention was made in view of the foregoing problem. An object of the present invention is to provide an input device, a control method of an input device, a controlled device, an electronic whiteboard system, a control program, and a storage medium, each of which enables a user to make, through a simple handwriting operation, an instruction to transmit a command to a controlled device provided outside, thereby improving user-friendliness.

### Solution to Problem

In order to solve the foregoing problem, an input device in accordance with one aspect of the present invention is an input device, having an input screen capable of accepting input of a track drawn by a user's handwriting operation, the input device capable of received information to a controlled device provided outside, the input device including: comparison means for comparing the track with a predetermined pattern so as to determine whether the track matches the predetermined pattern, by referring to a storage device in which a command and the predetermined pattern are stored in such a manner that the command and the predetermined pattern are associated with each other; and transmission means for, in a case where the comparison means determines that the track does not match the predetermined pattern, transmitting the track, and in a case where the comparison means determines that the track matches the predetermined pattern, transmitting the command associated with the predetermined pattern to which the track matches.

In order to solve the foregoing problem, a method in accordance with one aspect of the present invention for controlling an input device is a method for controlling an input device which has an input screen capable of accepting input of a track drawn by a user's handwriting operation and which is capable of receiving information based on the track and of transmitting the received information to a controlled device provided outside, the method including the steps of: (i) comparing the track with a predetermined pattern so as to determine whether the track matches the predetermined pattern, by referring to a storage device in which a command and the predetermined pattern are stored in such a manner that the command and the predetermined pattern are associated with each other; and (ii) performing transmission, in which in a case where it is determined in the step (i) that the track does not match the predetermined pattern, the track is transmitted, and in a case where it is determined in the step (i) that the track matches the predetermined pattern, the command associated with the predetermined pattern to which the track matches is transmitted.

### Advantageous Effects of Invention

With the input device in accordance with one aspect of the present invention and the method in accordance with one aspect of the present invention for controlling the input device, even if a user is in the middle of entering characters through a handwriting operation, the user can enter, through a simple handwriting operation, a command for causing the controlled device to execute a predetermined process. Accordingly, the input device in accordance with one aspect of the present invention and the method in accordance with one aspect of the present invention for controlling the input device can improve user-friendliness.

### BRIEF DESCRIPTION OF DRAWINGS

FIG. 1 is a block diagram illustrating a configuration of a main part of an electronic whiteboard including an input device and a display device in accordance with one embodiment of the present invention.

FIG. 2 is a view schematically illustrating an example of a handwriting operation which a user makes on an input screen of the input device and an example of handwritten character displayed on a display section by the display device. (a) of FIG. 2 illustrates an example of the handwriting operation and a track drawn by the handwriting operation, and (b) of FIG. 2 illustrates an example of the handwritten character.

FIG. 3 is a view schematically illustrating an example of a gesture made on the input screen of the input device.

FIG. 4 is a view schematically illustrating an example of handwritten character inputted by a user through a character input operation.

FIG. 5 is a view schematically illustrating an example where the handwritten character illustrated in FIG. 4 is changed to changed handwritten character according to the gesture illustrated in FIG. 3.

FIG. 6 is a view schematically illustrating an example of a gesture made on the input screen of the input device.

FIG. 7 is a view schematically illustrating an example where the handwritten character illustrated in FIG. 4 is changed to changed handwritten character according to the gesture illustrated in FIG. 6.

FIG. 8 is a view schematically illustrating an example of a gesture made on the input screen of the input device.

FIG. 9 is a view schematically illustrating an example where the handwritten character illustrated in FIG. 4 is changed to changed handwritten character according to the gesture illustrated in FIG. 8.

FIG. 10 is a view schematically illustrating examples of a pattern recognized by the input device as a gesture. (a) of FIG. 10 illustrates an example of a gesture which specifies a display form of a handwritten character by a diagonal line of a display region, (b) of FIG. 10 illustrates an example of a gesture associated with a command to cause the display device to execute a process to terminate an application, and (c) of FIG. 10 illustrates an example of a gesture making a shuttling operation two times.

FIG. 11 is a view schematically illustrating a relation between (i) a starting position, an ending position, and a turn-back position and (ii) a display position of a handwritten character. (a) of FIG. 11 illustrates a case where the turn-back position is located to the right of the starting position and the ending position, and (b) of FIG. 11 illustrates a case where the turn-back position is located to the left of the starting position and the ending position.

FIG. 12 is a view schematically illustrating an example of a track of a shuttling operation joining a starting position, an ending position, and a turn-back position by curved lines and a changed handwritten character displayed in accordance with this shuttling operation.

FIG. 13 is a flowchart illustrating an example of a process carried out by the input device and the display device.

FIG. 14 is a drawing schematically illustrating an example of use of a general electronic whiteboard.

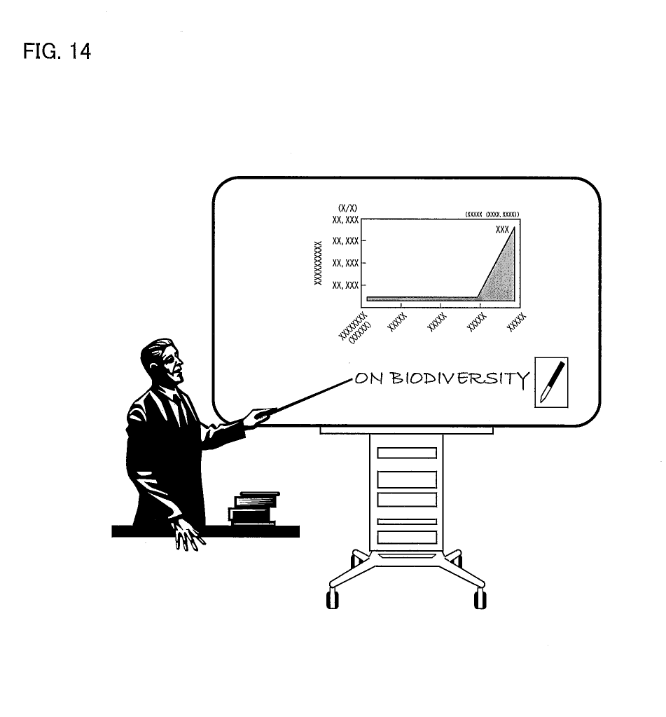

### DESCRIPTION OF EMBODIMENTS

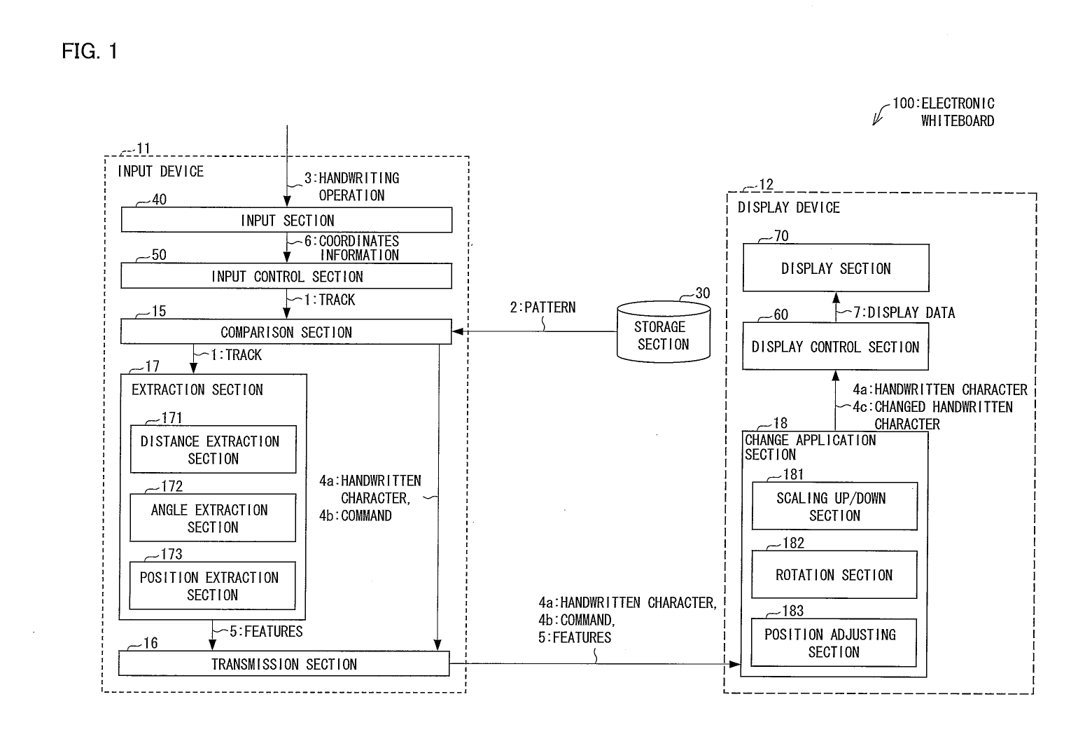

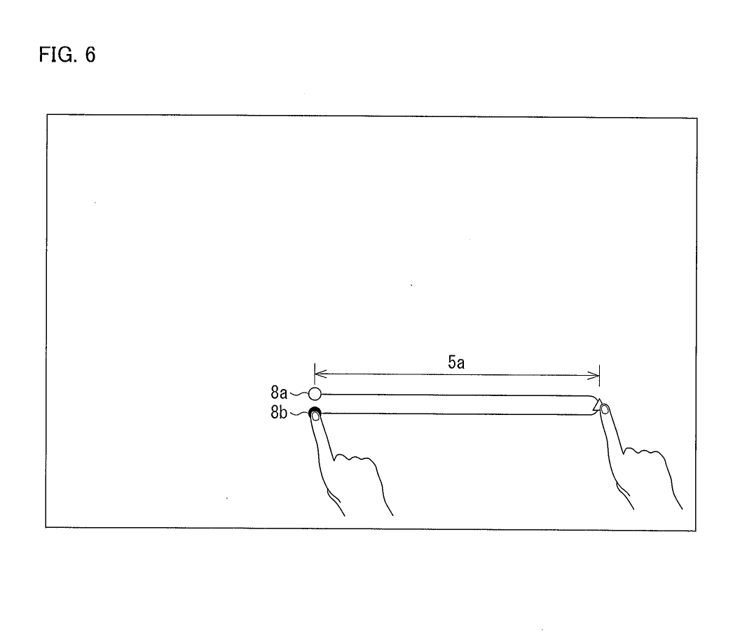

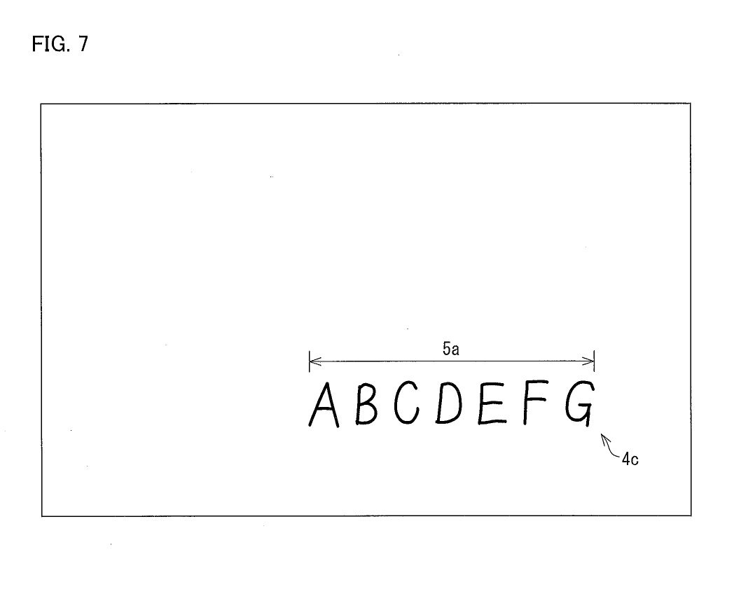

The following description will discuss an embodiment of the present invention in details with reference to FIGS. 1 to 13.

For the purpose of clearly showing relevance between individual information processed by an input device 11 and a display device 12, individual information given different member names may be given the same member number and distinguished from each other by affixing a, b, or c thereto. Specifically, a handwriting operation 3 includes a character input operation 3a and a gesture 3b. Input information 4 includes a handwritten character 4a, a command 4b, and a changed handwritten character 4c. Features 5 include a distance 5a, an angle (formed angle) 5b, and a position (starting position or ending position) 5c.

Furthermore, as for positions of the handwriting operation 3, a position to start the handwriting operation 3 is referred to as a starting position 8a, a position to end the handwriting operation 3 is referred to as an ending position 8b, and a position where a line drawn by the handwriting operation 3 is turned back is referred to as a turn-back position 8c. Lines forming the angle 5b include a horizontal line (predetermined reference line set for an input screen) 9a and an inclined line (line joining a starting position and a turn-back position) 9b.

### <Outlines of Input Device 11, Display Device 12, and Electronic Whiteboard 100>

With reference to FIG. 1, the following description will discuss an outline of an electronic whiteboard 100 including the input device 11 and the display device 12 in accordance with the present embodiment. FIG. 1 is a block diagram illustrating a configuration of a main part of the electronic whiteboard 100.

The input device 11 has an input screen capable of accepting an input by the user's handwriting operation 3 and is capable of transmitting, to the display device 12, input information 4 inputted via the input screen. Since the user makes the handwriting operation 3 by touching the input screen with an indicator such as a finger and a stylus (hereinafter merely referred to as “indicator”), the input device 11 can obtain two-dimensional coordinate information 6 indicative of coordinates of a position where the indicator touches the input screen.

The display device (controlled device) 12 receives the input information 4 (handwritten character 4a, command 5b) and the features 5 which are transmitted from the input device 11, subjects the input information 4 to a predetermined process, and causes a display section 70 to display the handwritten character 4a or the changed handwritten character 4c. The predetermined process is, as described later, a process in which the handwritten character 4a is subjected to a change in accordance with the features 5 as instructed by the command 4b received from the input device 11. The command 4b will be detailed later.

The electronic whiteboard (electronic whiteboard system) 100 is an input-output system including the input device 11 and the display device 12. For example, a user can cause the display device 12 to display a reference for presentation. Furthermore, the user can add characters, drawings etc. to the displayed reference by adding the input information 4 to the input device 11 through the handwriting operation 3.

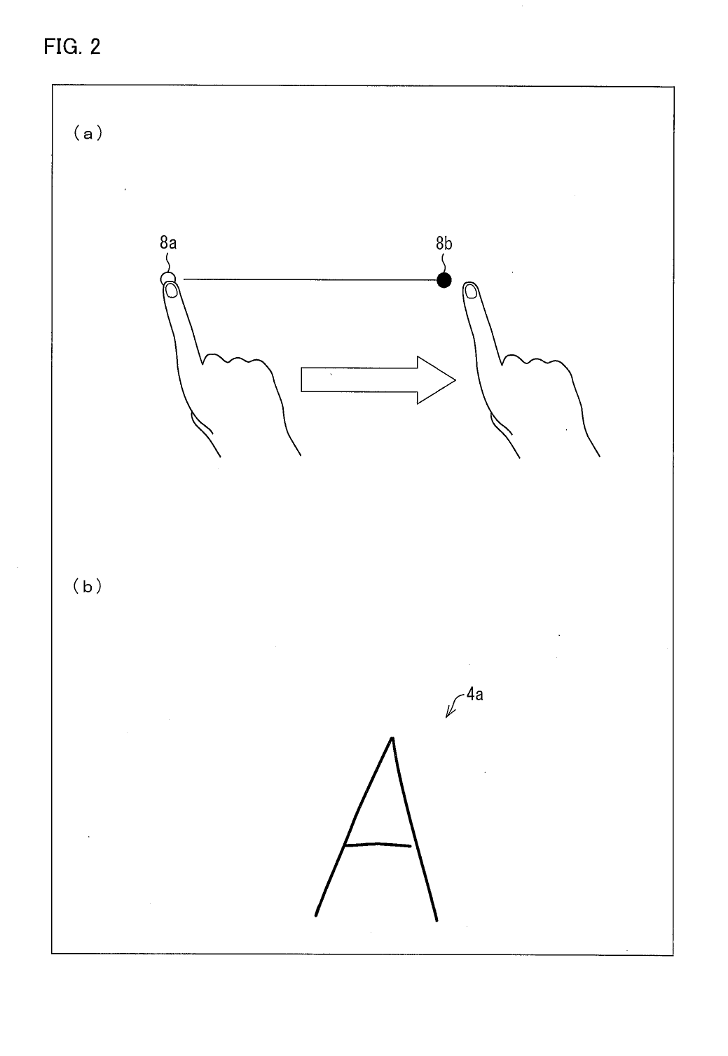

With reference to FIG. 2, the following description will discuss outlines of operations of the input device 11 and the display device 12. FIG. 2 is a view schematically illustrating an example of the handwriting operation 3 which a user makes on the input screen of the input device 11 and an example of the handwritten character 4a displayed on the display section 70 by the display device 12. (a) of FIG. 2 illustrates an example of the handwriting operation 3 and a track 1 drawn by the handwriting operation 3, and (b) of FIG. 2 illustrates an example of the handwritten character 4a. Note that a character expressed as a collection of the track 1 is referred to as the handwritten character 4a. For convenience, the following description will discuss only a case where the collection of the track 1 inputted through the handwriting operation 3 is a character, but the collection of the track 1 may be any figure.

As illustrated in (a) of FIG. 2, when a user makes the handwriting operation 3 with an indicator (finger in FIG. 2) touching the input screen of the input device 11, the track 1 of the indicator from the starting position 8a (position where the user causes the indicator to touch the input screen) of the handwriting operation 3 to the ending position 8b (position where the user causes the indicator to be detached from the input screen) of the handwriting operation 3 is inputted as the input information 4 to the input device 11. In FIG. 2, the starting position 8a is indicated by a white circle and the ending position 8b is indicated by a black circle. This is intended for clearly indicating where the starting position 8a and the ending position 8b are in the drawing, and the starting position 8a and the ending position 8b are not indicated by circles in reality. The same is true for the turn-back position 8c which will be mentioned later.

As illustrated in (b) of FIG. 2, the user can input the handwritten character 4a to the input device 11 by repeating the handwriting operation 3. The handwriting operation 3 which allows input of the handwritten character 4a is referred to as “character input operation 3a” in particular. The input device 11 in accordance with the present embodiment transmits the handwritten character 4a to the display device 12. Consequently, the display section 70 of the display device 12 displays the handwritten character 4a.

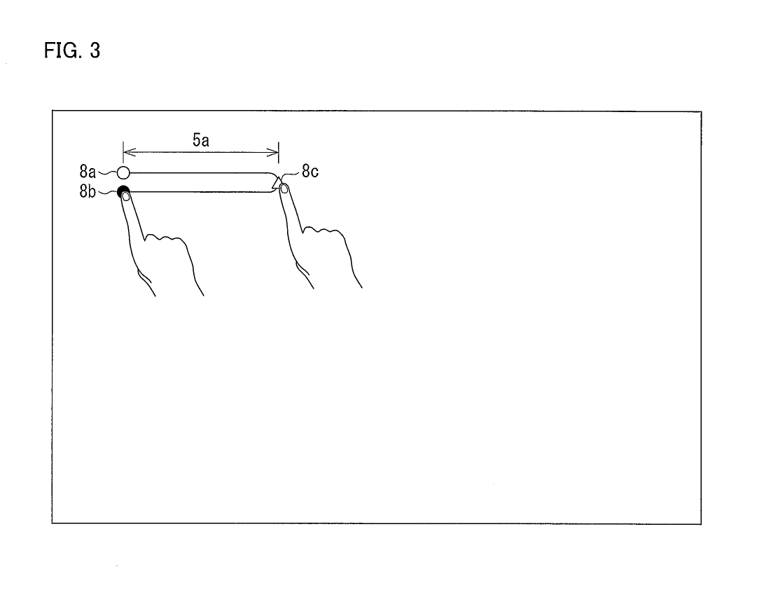

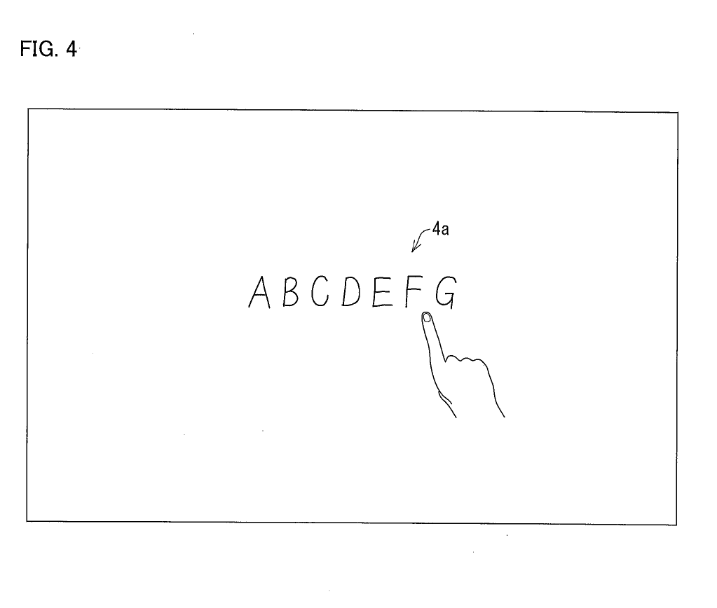

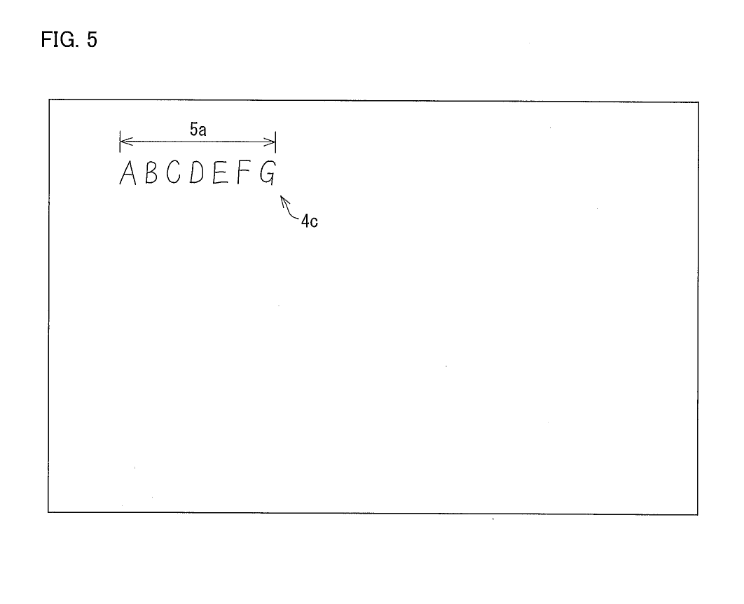

With reference to FIGS. 3 to 9, the following description will further discuss the outlines of the operations of the input device 11 and the display device 12. FIGS. 3, 6, and 8 are each a view schematically illustrating an example of the gesture 3b made on the input screen of the input device 11. FIG. 4 is a view schematically illustrating an example of the handwritten character 4a inputted by the user through the character input operation 3a. FIGS. 5, 7, and 9 are views schematically illustrating examples where the handwritten character 4a illustrated in FIG. 4 is changed to the changed handwritten character 4c according to the gesture 3b illustrated in FIGS. 3, 6, and 8, respectively.

As illustrated in FIGS. 3, 6, and 8, the input device 11 recognizes the gesture 3b inputted by the user. The gesture 3b herein is a shuttling operation as illustrated in FIGS. 3, 6, and 8, namely, an operation drawn by a substantially straight line starting at the starting position 8a and ending at the ending position 8b via the turn-back position 8c different from the starting position 8a, the ending position 8b being substantially identical with the starting position 8a.

The input device 11 compares the track 1 with a predetermined pattern 2, and determines whether the track 1 matches the pattern 2. The pattern 2 to be compared may be plural. In this case, the input device 11 compares the track 1 with all the patterns one by one. In the present embodiment, the pattern 2 is a pattern of a track drawn when the user makes a shuttling operation. Since the pattern 2 herein is defined to tolerate an error to such an extent that the character input operation 3a and the gesture 3b are not confused with each other, the track 1 may not be exactly identical with the pattern 2.

In a case where it is determined that the track 1 does not match the pattern 2, the input device 11 transmits the track 1 as the handwritten character 4a to the display device 12 without subjecting the track 1 to other process. On the other hand, in a case where it is determined that the track 1 matches the pattern 2, the input device 11 extracts the features 5 of the track 1. Then, the input device 11 transmits, to the display device 12, (i) the command 4b associated with the pattern 2 to which the track 1 matches and (ii) the features 5.

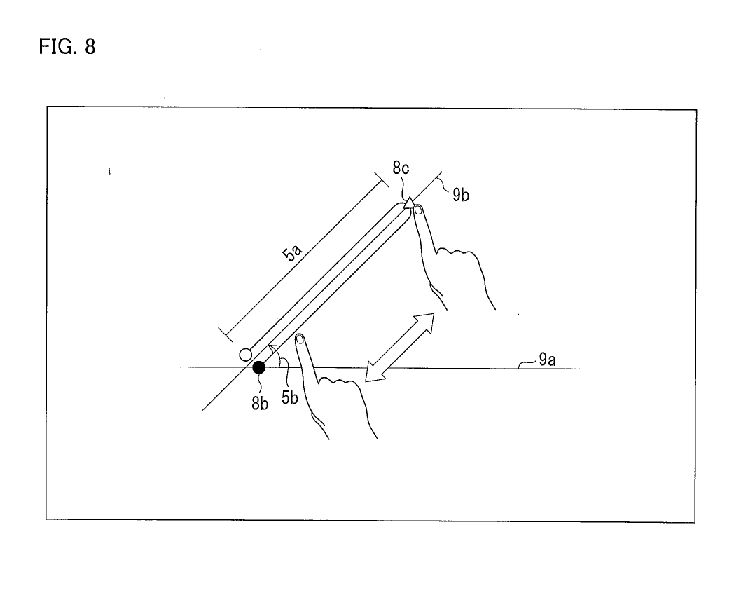

Examples of the features 5 herein include, as illustrated in FIGS. 3, 6, and 8, the starting position 8a, the ending position 8b, and the turn-back position 8c of the gesture 3b which is a shuttling operation, or the distance 5a between the starting position 8a or the ending position 8b and the turn-back position 8c. Alternatively, an example of the features 5 is, for example, as illustrated in FIG. 8, the angle 5b formed between the horizontal line 9a and the inclined line 9b.

As illustrated in FIG. 4, the input device 11 extracts the features 5 and then accepts the character input operation 3a by the user. Then, the input device 11 causes the handwritten character 4a inputted through the character input operation to be changed in accordance with the features 5, and causes the display device 12 to display the changed handwritten character 4c.

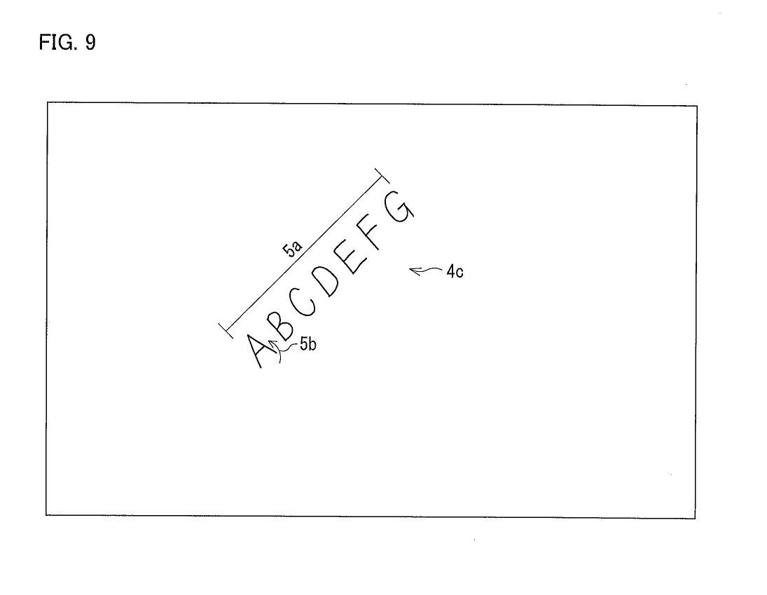

As illustrated in FIGS. 5, 7, and 9 for example, the input device 11 causes the display section 70 of the display device 12 to display the handwritten character 4a at a position corresponding to the starting position 8a or the ending position 8b of the gesture 3b. Alternatively, as illustrated in FIGS. 5, 7, and 9, the input device 11 causes the display section 70 to display the handwritten character 4a in such a manner that the height and the width of the handwritten character 4a are scaled up or down in accordance with the distance 5a of the gesture 3b. Alternatively, as illustrated in FIG. 9, the input device 11 causes the display section 70 to display the handwritten character 4a in such a manner that the handwritten character 4a is rotated in accordance with the angle 5b of the gesture 3b.

The following is a summary of the above description provided with reference to FIGS. 2 to 5. In a case where the handwriting operation 3 made by the user on the input device 11 is the character input operation 3a, the input device 11 transmits the track 1 as the handwritten character 4a to the display device 12, and in a case where the handwriting operation 3 is the gesture 3b, the input device 11 transmits the command 4b and the features 5 to the display device 12.

In a case where the display device 12 receives the handwritten character 4a from the input device 11, the display device 12 causes the display section 70 to display the handwritten character, and in a case where the display device 12 receives the command 4b and the features 5 from the input device 11, the display device 12 subjects the handwritten character 4a subsequently transmitted thereto to a change in accordance with the command 4b and the features 5 and causes the display section 70 to display the changed handwritten character 4c obtained as a result of the change.

Thus, the user can supply the command 4b to the display device 12 by drawing the track 1 identical with the pattern 2 through the gesture 3b. Specifically, in a case where the command is one which instructs the display device 12 to make a predetermined change on the handwritten character 4a, the input device 11 can cause the display device 12 to make the change on the handwritten character 4a.

The gesture 3b for giving the command may be, for example, only a shuttling operation on the input screen. That is, unlike the conventional art, the present invention does not require a complicated operation including several steps in making a change to the handwritten character 4a. This enables the user to cause the input device 11 to display the handwritten character 4a by making only a simple and intuitive operation, thereby improving user-friendliness.

Furthermore, since a user interface (UI) for making the change is not required, the cost for developing the UI can be reduced.

### [Configuration of Electronic Whiteboard 100]

With reference to FIG. 1, the following description will discuss in details individual components of the electronic whiteboard 100 including the input device 11 and the display device 12 in accordance with the present embodiment. As illustrated in FIG. 1, the electronic whiteboard 100 includes the input device 11, the display device 12, and a storage device 30.

The input device 11 includes an input section (input screen capable of accepting input of a track) 40, an input control section 50, a comparison section (comparison means) 15, an extraction section (extraction means) 17, and a transmission section (transmission means) 16. The display device 12 includes a change application section (execution means) 18, a display control section (output means) 60, and the display section (output means) 70. The extraction section 17 includes a distance extraction section 171, an angle extraction section 172, and a position extraction section 173. The change application section 18 includes a scaling up/down section 181, a rotation section 182, and a position adjusting section 183.

For simplicity of description, parts which are not directly related to the present embodiment (e.g. parts for achieving connection with an external device, printer function etc.) are omitted in the explanation on the configuration and in the block diagram. However, the electronic whiteboard 100 in accordance with the present embodiment may include the omitted parts according to the actual condition under which the invention is carried out.

The following description will discuss functions of individual components of the input device 11 (input section 40, input control section 50, comparison section 15, extraction section 17, and transmission section 16), the display device 12 (change application section 18, display control section 60, and display section 70), and the storage device 30 in this order.

### (Input Device 11)

The input device 11 is a device which is capable of receiving information via an input screen (input section 40) capable of accepting a track through a handwriting operation by a user and which transmits the received information to the display device 12.

The input section 40 accepts the handwriting operation 3 by the user. In the present embodiment, an example of the input section 40 is mainly a touch panel. However, the type of hardware for the input section 40 is not limited as long as the hardware has an input screen capable of accepting input of information to the display device 12 through the handwriting operation 3 by the user (i.e. the input screen is encompassed in the input section 40). The input section 40 supplies, to the input control section 50, two-dimensional coordinates information 6 of an indicator on the input screen which indicator touches the input screen.

The input control section 50 detects the track 1 drawn by the handwriting operation 3 by the user on the input screen of the input section 40. For example, the input control section 50 receives the coordinates information 6 from the input section 40 at a predetermined time interval, and supplies a series of coordinates data as the track 1 to the comparison section 15.

The comparison section 15 determines whether the track 1 is identical with the pattern 2. The storage device 30 stores the command 4b to the display device 12 and a predetermined pattern 2 in such a manner that the command 4b is associated with the predetermined pattern 2. The comparison section 15 compares the track 1 drawn by the handwriting operation 3 supplied from the input control section 50 with the pattern 2 read out from the storage device 30 so as to determine whether the track 1 matches the pattern 2.

In a case where it is determined that the track 1 does not match the pattern 2 (the track is the handwritten character 4a drawn by the character input operation 3a), the comparison section 15 supplies the handwritten character 4a to the transmission section 16.

On the other hand, in a case where it is determined that the track 1 matches the pattern 2 (the track is an input operation of the command 4b through the gesture 3b), the comparison section 15 supplies the command 4b associated with the pattern 2 to the transmission section 16 and supplies the track 1 to the extraction section 17.

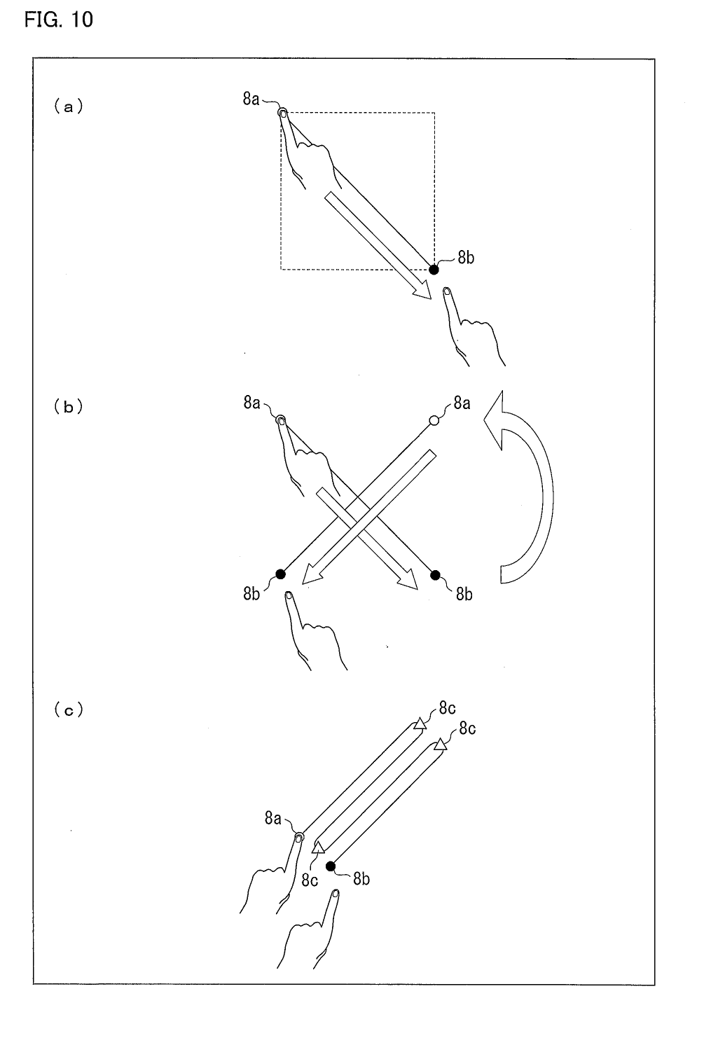

In this case, the comparison section 15 supplies, to the transmission section 16, the handwritten character 4a which is a track 1 supplied from the input control section 50 subsequently to the track 1 matching the pattern 2. Herein, the comparison section 15 detects whether the operation to input the handwritten character (character input operation 3a) has been completed or not. A method for the detection is, for example, as follows: a time having elapsed after the input operation was made is measured, and when the elapsed time exceeds a predetermined limit time, the comparison section 15 detects that the input operation has been completed and supplies the handwritten character 4a to the transmission section 16. Alternatively, the comparison section 15 may detect that the input operation has been completed, in a case where the comparison section 15 detects a predetermined gesture by a user. For example, the case may be a case where a track 1 supplied from the input control section 50 to the comparison section 15 subsequently to the input operation matches the pattern 2 or a case where a track 1 supplied from the input control section 50 to the comparison section 15 subsequently to the input operation matches other pattern (e.g. a later-mentioned pattern illustrated in (b) of FIG. 10).

The extraction section 17 extracts the features 5 of the track 1 supplied from the comparison section 15. Specifically, the distance extraction section 171 extracts the distance 5a of the track 1, the angle extraction section 172 extracts the angle 5b of the track 1, and the position extraction section 173 extracts the position 5c of the track 1. The extraction section 17 supplies, to the transmission section 16, the features 5 of the track 1 which have been extracted by the distance extraction section 171, the angle extraction section 172, and the position extraction section 173.

The transmission section 16 transmits, to the change application section 18 of the display device 12, (i) the input information 4 (handwritten character 4a, command 4b) supplied from the comparison section 15 and (ii) the features 5 (distance 5a, angle 5b, and position 5c) supplied from the extraction section 17.

### (Display Device 12)

The display device 12 is a device which receives the input information 4 (handwritten character 4a, command 4b) and the features 5 (distance 5a, angle 5b, and position 5c) which have been supplied from the input device 11, subjects the input information 4 to a predetermined process, and causes the display section 70 to display the input information 4 thus processed.

When the change application section 18 receives the features 5 from the transmission section 16 of the input device 11, the change application section 18 makes a change to the handwritten character 4a supplied from the transmission section 16, in accordance with the features. Specifically, the scaling up/down section 181 scales up/down the handwritten character 4a in accordance with the distance 5a. The rotation section 182 rotates the handwritten character 4a in accordance with the angle 5b. The position adjusting section 183 determines a position where the handwritten character 4a is to be displayed on the display section 70, in accordance with the position 5c.

The position adjusting section 183 causes the changed handwritten character 4c to be displayed at, for example, a position where any point on a side of a bound rectangle circumscribing the whole of the changed handwritten character 4c, which side is closer to a front end of the character string, is identical with the starting position 8a. The scaling up/down section 181 scales up/down the handwritten character 4a while keeping an aspect ratio of the bound rectangle.

The change made by the change application section 18 to the handwritten character 4a can be considered as changing the handwritten character 4a in such a manner that the starting position 8a or the ending position 8b is on a side of the bound rectangle which side is closer to a front end of the character string and the turn-back position 8c is on a side of the bound rectangle which side is opposite to the side closer to the front end of the character string and is closer to a rear end of the character string. However, it is not always necessary to align both ends of the rectangle with positions defined by the gesture 3b as above. Instead, for example, the scaling up/down section 181 may change the handwritten character 4a so that the handwritten character 4a has a length equal to a real number multiple of the distance 5a (i.e. so that a ratio of scaling up/down the handwritten character 4a is in proportion to the length 5a).

The change application section 18 supplies the handwritten character 4a having been changed by individual sections, as the changed handwritten character 4c to the display control section 60. However, in a case where only the handwritten character 4a is supplied and the command 4b and the features 5 are not supplied from the transmission section 16, the change application section 18 supplies the handwritten character 4a to the display control section 60 without making any change to the handwritten character 4a.

The display control section 60 converts information (e.g. handwritten character 4a) supplied from the input device 11, into display data 7 in a format displayable on the display section 70. Examples of the display data 7 include an image in a bitmap format, an image in other format, and data in a format suitable for display. The display control section 60 is not limited as long as it can format-convert the information into the display data 7, and may be a general display adaptor for example.

The display section 70 is a device for displaying an image etc. In the present embodiment, an example of the display section 70 is mainly a liquid crystal display (LCD). However, the type of hardware for the display section 70 is not limited as long as the hardware is a device having a display function (flat panel display in particular). For example, a display section 70a can be constituted by at least a device including a display element such as a plasma display panel (PDP) and an EL (electroluminescence) display and a driver circuit for driving the display element in accordance with the display data 7 supplied from the display control section 60.

FIG. 1 illustrates the input section 40 and the display section 70 separately in order to clearly show respective functions of the input section 40 and the display section 70. However, in a case where, for example, the input section 40 is a touch panel and the display section 70 is a liquid crystal display, it is desirable that the input section 40 and the display section 70 be configured integrally. That is, the input section 40 may be configured to include a data input screen composed of a clear transmitting member having a rectangular plate shape, such as a glass, and to be integral with the display section 70 in such a manner as to cover a data display screen of the display section 70. As a result, a position where the indicator touches the input screen of the input section 40 is identical with a position of a figure which the display section 70 displays on the display screen in accordance with the touch. This enables a user to have a natural handwriting feeling.

### (Storage Device 30)

The storage device 30 is a non-volatile storage device in which the pattern 2 is stored. The storage device 30 may be constituted by, for example, a hard disk, a semiconductor memory, a DVD (Digital Versatile Disk) or the like. In the present embodiment, the storage device 30 is illustrated in FIG. 1 as a device built in the electronic whiteboard 100 separately from the input device 11 and the display device 12. Alternatively, the storage device 30 may be an internal storage device built in the input device 11 or the display device 12, or may be an external storage device provided outside the electronic whiteboard 100 and communicably connected with the electronic whiteboard 100.

[Types of Gesture 3b and Command 4b]

With reference to FIG. 10, the following description will discuss types of the gesture 3b. FIG. 10 is a view schematically illustrating examples of the pattern 2 recognized by the input device 11 as the gesture 3b. (a) of FIG. 10 illustrates an example of a gesture which specifies a display form (position, size) of the handwritten character 4a by a diagonal line of a display region, (b) of FIG. 10 illustrates an example of a gesture associated with the command 4b to cause the display device 12 to execute a process to terminate an application, and (c) of FIG. 10 illustrates an example of a gesture making a shuttling operation two times.

As illustrated in the example of (a) of FIG. 10, a user can specify the display form of the handwritten character 4a by a diagonal line of a rectangular display region. In this case, the input device 11 determines the size and the display position of the handwritten character 4a so that the handwritten character 4a is positioned within the rectangular display region specified by the diagonal line, and displays the handwritten character 4a as the changed handwritten character 4c.

The input device 11 may recognize the gesture 3b illustrated in the example of (b) of FIG. 10, as an input indicative of transmission of the command 4b. In this case, the command 4b supplied from the input device 11 to the display device 12 may be one instructing the display device 12 to terminate an application for character inputs or one instructing the electronic whiteboard 100 to be turned off.

That is, (i) the gesture 3b defined as the pattern 2 and (ii) the command 4b stored in the storage device 30 in such a manner as to be associated with the pattern 2 can be defined freely. Accordingly, by taking a combination of the gesture 3b and the command 4b into account, the electronic whiteboard 100 enables a user to make intuitive operations of various devices through the handwriting operation 3.

However, it is desirable that the gesture 3b be defined in such a manner as to be clearly distinguished by the input device 11 from the character input operation 3a. This is because when the character input operation 3a includes a track corresponding to the gesture 3b, the input device 11 confuses the character input operation 3a with the gesture 3b so that the input device 11 executes the command 4b which is not intended by a user.

For this reason, the above shuttling operation (operation drawn by a substantially straight line starting at the starting position 8a and ending at the ending position 8b via the turn-back position 8c different from the starting position 8a, the ending position 8b being substantially identical with the starting position 8a) is preferable as the gesture 3b since such a shuttling operation is not made in a normal input of a character, figure etc.

Furthermore, the shuttling operation is most preferable as the gesture 3b associated with the command 4b for changing a handwritten character, since the shuttling operation allows the features 5 such as the starting position 8a, the ending position 8b, the turn-back position 8c, the distance 5a, and the angle 5b to be inputted through a single handwriting operation.

Furthermore, for example, the gesture 3b making the shuttling operation two times as illustrated in the example of (c) of FIG. 10 is suitable for, for example, an instruction to terminate an application for character inputs or an instruction to turn off a power of the electronic whiteboard 100, since the gesture 3b making such an shuttling operation is less likely to be confused with the character input operation 3a and is not so complicated as to be troublesome for a user to input.

While the present embodiment describes the electronic whiteboard 100 including the input device 11 and the display device 12, it should be noted that a device to be used in combination with the input device 11 is not limited to the display device 12, and a system composed of the input device 11 and the device to be used in combination with the input device 11 is not limited to the electronic whiteboard 100.

For example, a personal computer or a mobile phone, which allows a more general-purpose process, may be used in combination with the input device 11 to accept input of a command 4b. In this case, a command 4b to instruct transmission of e-mail, activation of an Internet browser etc. may be associated with a suitable gesture 3b. This allows a user to carry out the aforementioned process through a simple and intuitive operation of the handwriting operation 3, unlike the conventional art in which a user must make a troublesome operation via a mouse, keyboard etc.

### [Display Form of Changed Handwritten Character 4c]

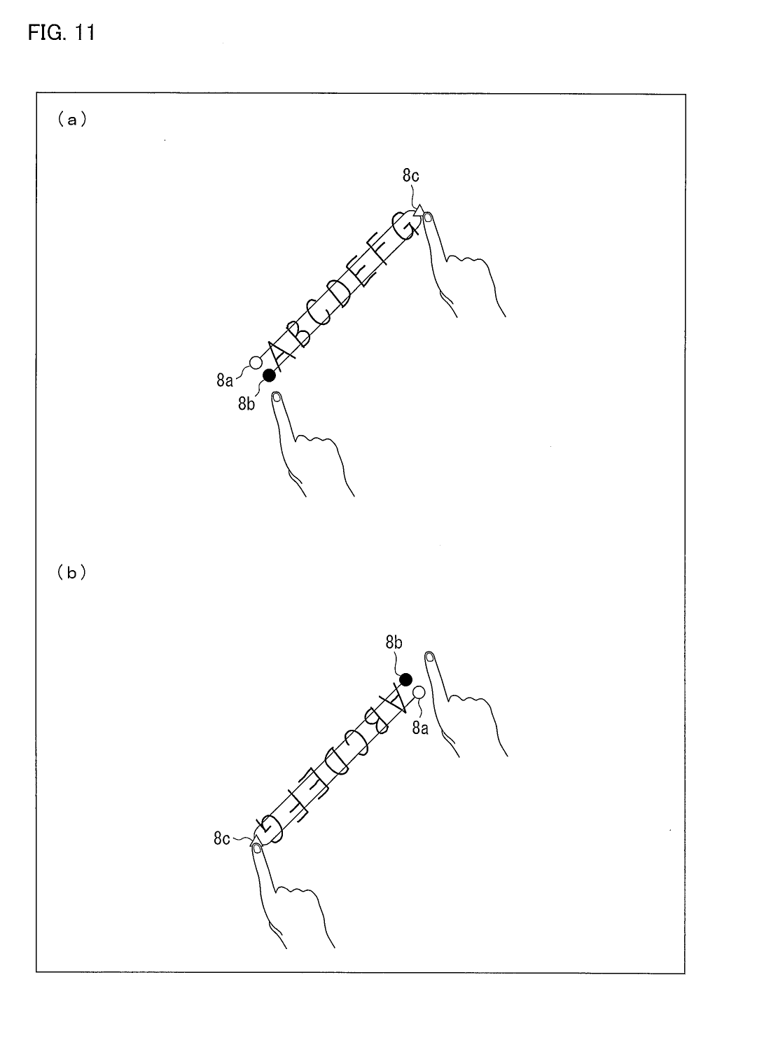

With reference to FIG. 11, the following description will discuss a display form of the changed handwritten character 4c. FIG. 11 is a view schematically illustrating a relation between (i) the starting position 8a, the ending position 8b, and the turn-back position 8c and (ii) the display position of the handwritten character 4a. (a) of FIG. 11 illustrates a case where the turn-back position 8c is located to the right of the starting position 8a and the ending position 8b, and (b) of FIG. 11 illustrates a case where the turn-back position 8c is located to the left of the starting position 8a and the ending position 8b.

As described above, the change application section 18 causes the changed handwritten character 4c to be displayed at a position where any point on a side of a bound rectangle circumscribing the whole of the changed handwritten character 4c, which side is closer to a front end of the character string, is identical with the starting position 8a. Consequently, depending on a positional relationship between the starting position 8a or the ending position 8b and the turn-back position 8c, the handwritten character 4a is displayed in an inverted manner as illustrated in the example of (b) of FIG. 11.

### [Modification of Shuttling Operation]

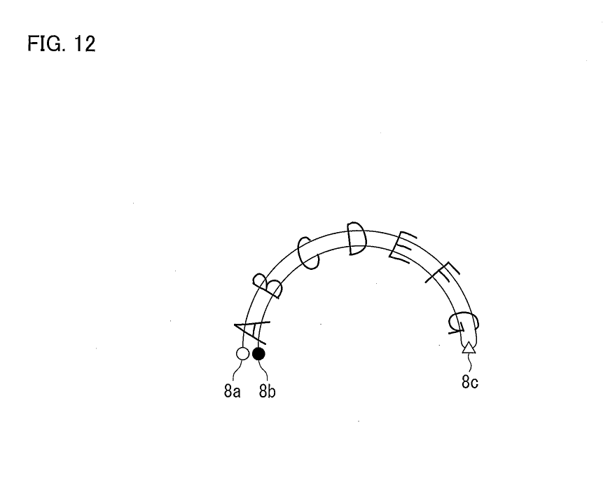

With reference to FIG. 12, the following description will discuss a modification of a shuttling operation (see FIGS. 3, 6, and 8) included in the gesture 3b. FIG. 12 is a view schematically illustrating an example of a track 1 of a shuttling operation joining the starting position 8a, the ending position 8b, and the turn-back position 8c by curved lines and a changed handwritten character 4c displayed in accordance with this shuttling operation.

In a case where the shuttling operation composed of curved lines as illustrated in the example of FIG. 12 is made, the handwritten character 4a is displayed in such a manner as to be curved along the curved lines. This allows a user to display a character in more various manners through the simple gesture 3b.

### [Process Carried Out by Display Device 12]

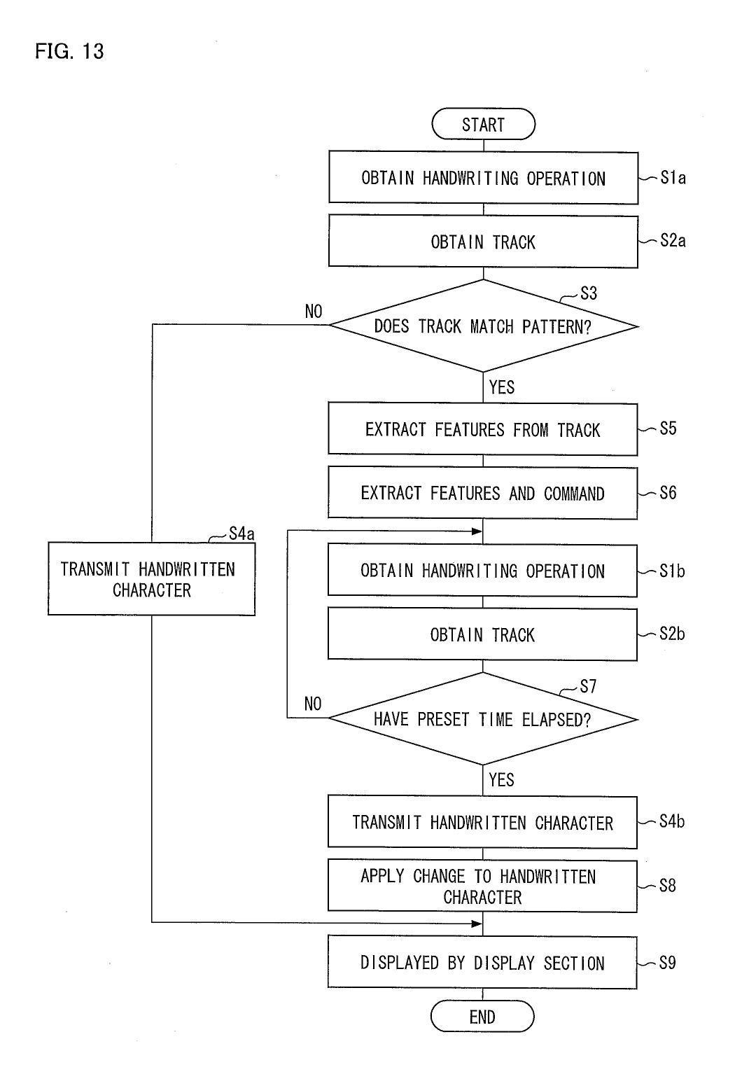

With reference to FIG. 13, the following description will discuss a flow of a process carried out by the display device 12. FIG. 13 is a flowchart illustrating an example of a process carried out by the input device 11 and the display device 12.

Initially, the input section 40 accepts the handwriting operation 3 by a user, and supplies the coordinate information 6 to the input control section 50 (step 1a: the word “step” is hereinafter abbreviated as S, such as the step 1a abbreviated as S1a). Next, the input control section 50 obtains the track 1 of the handwriting operation 3 made by the user on the input screen of the input section 40, and supplies the track 1 to the comparison section 15 (S2a).

The comparison section 15 determines whether the track 1 supplied from the input control section 50 matches a predetermined pattern 2 stored in the storage device 30 (S3, the step of comparing). In a case where it is determined that the track 1 does not match the predetermined pattern 2 (NO in S3), the comparison section 15 supplies the track 1 as the handwritten character 4a to the transmission section 16. The transmission section 16 transmits, to the display device 12, the handwritten character 4a supplied from the comparison section 15 (S4a, the step of transmitting).

On the other hand, in a case where it is determined that the track 1 matches the pattern 2 (YES in S3), the comparison section 15 supplies the command 4b associated with the pattern 2 to the transmission section 16. At the same time, the comparison section 15 supplies the track 1 to the extraction section 17. The extraction section 17 extracts the features 5 from the track 1 supplied from the comparison section 15, and supplies the features 5 to the transmission section 16 (S5). The transmission section 16 transmits, to the display device 12, the command 4b supplied from the comparison section 15 and the features 5 supplied from the extraction section 17 (S6, the step of transmitting).

In a case where the change application section 18 of the display device 12 accepts input of the handwritten character 4a from the input device 11 (flow corresponding to NO in S3), the change application section 18 supplies the handwritten character as it is (without making any change to the handwritten character) to the display control section 60. The display control section 60 converts the handwritten character 4a supplied from the change application section 18 into the display data 7, so that the display control section 60 causes the display section 70 to display the handwritten character (S9). On the other hand, in a case where the change application section 18 accepts input of the command 4b and the features 5 from the input device 11 (flow corresponding to YES in S3), the change application section 18 waits for further accepting input of the handwritten character 4a from the input device 11.

Through processes similar to S1 and S2 mentioned above, the comparison section 15 accepts input of the track 1 (S1b, S2b). In a case where a predetermined time has elapsed (YES in S7), the comparison section 15 supplies the track 1 as the handwritten character 4a to the transmission section 16, and the transmission section 16 transmits the handwritten character 4a to the display device 12 (S4b). The change application section 18 makes a change in accordance with the features 5 to the handwritten character 4a supplied from the input device 11, as instructed by the command 4b (S8).

The change application section 18 supplies, to the display control section 60, the changed handwritten character 4c which is obtained by making the change to the handwritten character 4a. The display control section 60 converts the changed handwritten character 4c supplied from the change application section 18 into the display data 7, so that the display control section 60 causes the display section 70 to display the handwritten character (S9).

### [Effect Yielded by Input Device 11, Display Device 12, and Electronic Whiteboard 100]

A user can cause the display device 12 to carry out a predetermined process (e.g. subjecting the handwritten character 4a to a predetermined change and displaying the changed handwritten character 4c obtained as a result of the change), by giving the command 4b to the display device 12 through the gesture 3b. The gesture 3b is a simple handwriting operation 3, such as a shuttling operation on the input screen. That is, the user can cause the display device 12 to carry out the predetermined process by making only a simple and intuitive operation. Accordingly, the input device 11 can improve user-friendliness.

### [Summary]

An input device (input device 11) in accordance with one aspect of the present invention is

(1) an input device, having an input screen capable of accepting input of a track drawn by a user's handwriting operation, the input device capable of receiving information based on the track and of transmitting the received information to a controlled device provided outside, the input device including:
(2) comparison means for comparing the track with a predetermined pattern so as to determine whether the track matches the predetermined pattern, by referring to a storage device in which a command and the predetermined pattern are stored in such a manner that the command and the predetermined pattern are associated with each other; and
(3) transmission means for, in a case where the comparison means determines that the track does not match the predetermined pattern, transmitting the track, and in a case where the comparison means determines that the track matches the predetermined pattern, transmitting the command associated with the predetermined pattern to which the track matches.

In order to solve the foregoing problem, a method in accordance with one aspect of the present invention for controlling an input device is

(1) a method for controlling an input device which has an input screen capable of accepting input of a track drawn by a user's handwriting operation and which is capable of receiving information based on the track and of transmitting the received information to a controlled device provided outside, the method comprising the steps of:
(2) (i) comparing the track with a predetermined pattern so as to determine whether the track matches the predetermined pattern, by referring to a storage device in which a command and the predetermined pattern are stored in such a manner that the command and the predetermined pattern are associated with each other; and
(3) (ii) performing transmission, in which in a case where it is determined in the step (i) that the track does not match the predetermined pattern, the track is transmitted, and in a case where it is determined in the step (i) that the track matches the predetermined pattern, the command associated with the predetermined pattern to which the track matches is transmitted.

With the arrangement, the input device in accordance with one aspect of the present invention and the method in accordance with one aspect of the present invention for controlling the input device can determine whether the track inputted by the user's handwriting operation matches a predetermined pattern. In a case where it is determined that the track matches the predetermined pattern, the device and the method transmit a predetermined command associated with the pattern to the controlled device, and in a case where it is determined that the track does not match the predetermined pattern, the device and the method transmit the track as handwritten information to the controlled device.

As described above, in the conventional art, it is necessary for a user to make a complicated operation including several steps in order to cause a controlled device to carry out a predetermined process (e.g. subjecting an input character etc. to a predetermined change and displaying the changed input character).

In contrast, with the aforementioned input device etc., even if a user is in the middle of entering characters through a handwriting operation, the user can enter, through a simple handwriting operation, a command for causing the controlled device to execute a predetermined process. Accordingly, the input device etc. in accordance with one aspect of the present invention can improve user-friendliness.

The input device in accordance with one aspect of the present invention may be arranged so as to further include

(1) extraction means for extracting features of the track in a case where the comparison means determines that the track matches the predetermined pattern,
(2) the transmission means further transmitting the features extracted by the extraction means to the controlled device.

With the arrangement, the input device in accordance with one aspect of the present invention extracts features of the track inputted through the user's handwriting operation, and transmits the features together with the command to the controlled device. That is, the user can assign, to the command, parameters which are the features of the track, and transmit the command and the parameters to the controlled device.

Here, the above example in which the controlled device makes a predetermined change to handwritten information is considered. None of the conventional arts described in the aforementioned Patent Literatures allows a user to display inputted characters etc. as desired. In contrast, the input device of the present invention allows a user to specify a position where a handwritten character etc. is to be displayed, a size of the handwritten character, a rotation angle of the handwritten character etc. through a simple handwritten operation.

Consequently, the input device in accordance with one aspect of the present invention can improve user-friendliness, such as allowing a user to display, as desired, handwritten information entered by the user.

An input device in accordance with one aspect of the present invention may be arranged such that

(1) the comparison means determines whether the track matches a pattern drawn by a substantially straight line starting at a starting position and ending at an ending position via a turn-back position different from the starting position, the ending position being substantially identical with the starting position.

With the arrangement, the user is only required to make a shuttling operation on the input screen in order to cause the input device to transmit a command. Accordingly, the input device in accordance with one aspect of the present invention allows the user to transmit a command to a controlled device through an intuitive and simple operation.

The input device in accordance with one aspect of the present invention may be arranged such that

(1) the extraction means extracts, as one of the features, at least one of the starting position, the ending position, and the turn-back position.

With the arrangement, the input device in accordance with one aspect of the present invention extracts, as one of the features, at least one of the starting position, the ending position, and the turn-back position of the shuttling operation, and transmits said at least one of the starting position, the ending position, and the turn-back position, together with a command, to the controlled device. Consequently, the controlled device can display received information at, for example, the starting position etc. of the shuttling operation entered by the user.

The input device in accordance with one aspect of the present invention may be arranged such that

(1) the extraction means extracts, as one of the features, a distance between the starting position or the ending position and the turn-back position.

With the arrangement, the input device in accordance with one aspect of the present invention extracts, as one of the features, a distance between the starting position or the ending position and the turn-back position of the shuttling operation, and transmits the distance together with a command to the controlled device. Consequently, the controlled device can display received information in accordance with, for example, the distance of the shuttling operation entered by the user.

The input device in accordance with one aspect of the present invention may be arranged such that

(1) the extraction means extracts, as one of the features, an angle formed between a predetermined reference line set for the input screen and a line joining the starting position or the ending position and the turn-back position.

With the arrangement, the input device in accordance with one aspect of the present invention extracts the inclination (angle) of the shuttling operation as one of the features, and transmits the inclination together with a command to the controlled device. Consequently, the controlled device can display received information in such a manner that the received information is rotated in accordance with, for example, the inclination of the shuttling operation entered by the user.

The controlled device in accordance with one aspect of the present invention is a controlled device,

(1) including execution means for executing the command transmitted from the input device.

With the arrangement, the controlled device in accordance with one aspect of the present invention receives a command transmitted from the input device and executes a predetermined process defined by the command. Consequently, for example, in a case where the command defines making a predetermined change to handwritten information, it is possible to make a change intended by a user to handwritten information transmitted from the input device.

The controlled device in accordance with one aspect of the present invention may be arranged so as to

(1) further include output means for outputting a track transmitted from the input device.

With the arrangement, the controlled device in accordance with one aspect of the present invention receives the track transmitted from the input device and outputs the track. Therefore, a user can cause information inputted to the input device to be outputted from the controlled device.

The controlled device in accordance with one aspect of the present invention may be arranged such that

(1) the command is a command for instructing the controlled device to apply a change to the track, and
(2) in a case where the features are transmitted together with the command from the input device, the execution means applies, to the track, the change in accordance with the features.

With the arrangement, the controlled device in accordance with one aspect of the present invention makes a change to the track in accordance with the features of a track transmitted from the input device. Consequently, a user can cause handwriting information entered by the user to be displayed as desired.

An electronic whiteboard system in accordance with one aspect of the present invention may include:

(1) the aforementioned input device; and
(2) the aforementioned controlled device.

With the arrangement, a user can cause handwriting information entered by the user to be displayed as desired.

The input device and the controlled device may be realized by a computer. In this case, the present invention also encompasses (i) a control program for causing a computer to realize the input device and the controlled device by causing the computer to function as individual means of the input device and the controlled device, and (ii) a computer-readable storage medium in which the control program is stored.

### [Regarding Combination of Configurations (Technical Means) Disclosed in Individual Embodiments]

It should be noted that the configurations disclosed in individual embodiments mentioned above can be combined with each other appropriately. That is, all the configurations described in the above embodiments can be used not only in the embodiments describing the configurations but also in other embodiments by combining all of or a part of the configurations, and an embodiment obtained from such combination is also encompassed in the technical scope of the present invention.

The present invention is not limited to the description of the embodiments above, but may be altered by a skilled person within the scope of the claims. An embodiment based on a proper combination of technical means disclosed in different embodiments is encompassed in the technical scope of the present invention.

### [Examples Realized by Software]

Lastly it should be noted that each block of the input device 11 and the display device 12 (each block of the electronic whiteboard 100) may be realized by a logic circuit (hardware) provided on an integrated circuit (IC chip) or may be realized by software as executed by a CPU (Central Processing Unit).

In the latter case, the input device 11 and the display device 12 (electronic whiteboard 100) each include: a CPU that executes instructions of a program realizing the foregoing functions; and a storage device (storage medium) such as ROM (Read Only Memory) that stores the program, RAM (Random Access Memory) for developing the program, and a memory for storing the program and various kinds of data. The object of the present invention can be realized in such a manner that the input device 11 and the display device 12 are provided with a computer-readable storage medium for storing program codes (such as executable program, intermediate code program, and source program) of control programs of the input device 11 and the display device 12 (electronic whiteboard 100) which programs serve as software for realizing the functions, and a computer (alternatively, CPU or MPU) reads out and executes the program codes stored in the storage medium.

The storage medium is, for example, tapes such as a magnetic tape and a cassette tape, or discs such as magnetic discs (e.g. a Floppy Disc® and a hard disc), and optical discs (e.g. CD-ROM, MO, MD, DVD, and CD-R). Further, the storage medium may be cards such as an IC card (including a memory card) and an optical card, semiconductor memories such as mask ROM, EPROM, EEPROM, and flash ROM, or logic circuits such as PLD (Programmable Logic Device) and FPGA (Field Programmable Gate Array).

Further, the input device 11 and the display device 12 (electronic whiteboard 100) may be arranged so as to be connectable to a communication network so that the program code is made available to the input device 11 and the display device 12 (electronic whiteboard 100) through the communication network. The communication network is not particularly limited as long as it can transmit the program code. Examples of the communication network include the Internet, intranet, extranet, LAN, ISDN, VAN, CATV communication network, virtual private network, telephone network, mobile communication network, and satellite communication network. Further, a transmission medium that constitutes the communication network is not particularly limited as long as it can transmit the program code. Examples of the transmission medium include (i) wired lines such as IEEE 1394, USB, power-line carrier, cable TV lines, telephone lines, and ADSL (Asymmetric Digital Subscriber Line) and (ii) wireless connections such as IrDA and remote control using infrared ray, Bluetooth®, 802.11, HDR (High Data Rate), NFC (Near Field Communication), DLNA (Digital Living Network Alliance), mobile phone network, satellite connections, and terrestrial digital network. Note that the present invention can also be implemented by the program code in the form of a computer data signal embedded in a carrier wave which is embodied by electronic transmission.

### INDUSTRIAL APPLICABILITY

The present invention is applicable to electronic devices capable of being driven in response to input through a handwriting operation, such as electronic whiteboards, mobile phones, tablet terminals, personal computers, and others.

### REFERENCE SIGNS LIST

1 Track
2 Pattern
3 Handwriting operation
3a Character input operation
3b Gesture (shuttling operation)
4 Input information (information inputted through handwriting operation)
4a Handwritten character
4b Command
4c Changed handwritten character
5 Features
5a Distance
5b Angle (formed angle)
5c Position (starting position or ending position)
8a Starting position
8b Ending position
8c Turn-back position
9a Horizontal line (predetermined reference line set for input screen)
9b Inclined line (line joining starting position and turn-back position)
11 Input device
12 Display device (controlled device)
15 Comparison section (comparison means)
16 Transmission section (transmission means)
17 Extraction section (extraction means)
18 Change application section (execution means)
30 Storage device
40 Input section (input screen capable of accepting input of a track)
60 Display control section (output means)
70 Display section (output means)
100 Electronic whiteboard (electronic whiteboard system)

1. An input device, having an input screen capable of accepting input of a track drawn by a user's handwriting operation, the input device capable of receiving information based on the track and of transmitting the received information to a controlled device provided outside,
the input device comprising:
comparison means for comparing the track with a predetermined pattern so as to determine whether the track matches the predetermined pattern, by referring to a storage device in which a command and the predetermined pattern are stored in such a manner that the command and the predetermined pattern are associated with each other; and
transmission means for, in a case where the comparison means determines that the track does not match the predetermined pattern, transmitting the track, and in a case where the comparison means determines that the track matches the predetermined pattern, transmitting the command associated with the predetermined pattern to which the track matches.

2. The input device as set forth in claim 1, further comprising extraction means for extracting features of the track in a case where the comparison means determines that the track matches the predetermined pattern,
the transmission means further transmitting the features extracted by the extraction means to the controlled device.

3. The input device as set forth in claim 2, wherein the comparison means determines whether the track matches a pattern drawn by a substantially straight line starting at a starting position and ending at an ending position via a turn-back position different from the starting position, the ending position being substantially identical with the starting position.

4. The input device as set forth in claim 3, wherein the extraction means extracts, as one of the features, at least one of the starting position, the ending position, and the turn-back position.

5. The input device as set forth in claim 3, wherein the extraction means extracts, as one of the features, a distance between the starting position or the ending position and the turn-back position.

6. The input device as set forth in claim 3, wherein the extraction means extracts, as one of the features, an angle formed between a predetermined reference line set for the input screen and a line joining the starting position or the ending position and the turn-back position.

7. The input device as set forth in claim 1, wherein the comparison means determines whether the track matches a pattern drawn by a substantially straight line starting at a starting position and ending at an ending position via a turn-back position different from the starting position, the ending position being substantially identical with the starting position.

8. A controlled device, comprising execution means for executing the transmitted from an input device as set forth in claim 1.

9. The controlled device as set forth in claim 8, further comprising output means for outputting a track transmitted from the input device.

10. The controlled device as set forth in claim 8, wherein
the command is a command for instructing the controlled device to apply a change to the track, and
in a case where the features are transmitted together with the command from the input device, the execution means applies, to the track, the change in accordance with the features.

11. An electronic whiteboard system, comprising:
an input device as set forth in including comparison means for comparing the track with a predetermined pattern so as to determine whether the track matches the predetermined pattern, by referring to a storage device in which a command and the predetermined pattern are stored in such a manner that the command and the predetermined pattern are associated with each other; and
transmission means for, in a case where the comparison means determines that the track does not match the predetermined pattern, transmitting the track, and in a case where the comparison means determines that the track matches the predetermined pattern transmitting the command associated with the predetermined pattern to which the track matches; and
a controlled device as set forth in claim 8.

12. A method for controlling an input device which has an input screen capable of accepting input of a track drawn by a user's handwriting operation and which is capable of receiving information based on the track and of transmitting the received information to a controlled device provided outside,
the method comprising the steps of:
(i) comparing the track with a predetermined pattern so as to determine whether the track matches the predetermined pattern, by referring to a storage device in which a command and the predetermined pattern are stored in such a manner that the command and the predetermined pattern are associated with each other; and
(ii) performing transmission, in which in a case where it is determined in the step (i) that the track does not match the predetermined pattern, the track is transmitted, and in a case where it is determined in the step (i) that the track matches the predetermined pattern, the command associated with the predetermined pattern to which the track matches is transmitted.

13. (canceled)

14. A non-transitory and computer-readable storage medium, in which a control program for causing an input device as set forth in claim 1 is stored, the control program causing a computer to function as each means of the input device.
